(19) United States
(12) Patent Application Publication
(10) Pub. No.: US 2021/0272173 A1
(43) Pub. Date: Sep. 2, 2021

(54) SYSTEM AND METHOD FOR TRADE BY TRADE

(71) Applicant: Yuri Minchenko, Farmington, CT (US)

(72) Inventor: Yuri Minchenko, Farmington, CT (US)

(21) Appl. No.: 17/326,002

(22) Filed: May 20, 2021

Related U.S. Application Data
(60) Provisional application No. 63/082,186, filed on Sep. 23, 2020.

(51) Int. Cl. G06Q 30/06

(52) U.S. Cl. CPC G06Q 30/0611

(57) ABSTRACT

A trade-by-trade platform for trading a necessity in return for another necessity. The disclosed platform can provide an interface for the first user and the second user to upload the necessities for exchange. The platform can receive the listings through the interface and store them in a structured format that can be queried through the interface. Either user can search for listings or navigate to find a desired necessity. Upon finding the desired necessity, the user can make an offer to the owner of desired necessity. The offer can include an interest in the desired necessity and listed offered necessity for exchange.

### CROSS-REFERENCE TO RELATED APPLICATIONS

This application claims priority to the U.S. provisional patent application Ser. No. 63/082,186, filed on Sep. 23, 2020, which is incorporated herein by reference in its entirety.

### FIELD OF INVENTION

This application relates to a system and method for trade, and more particularly, this application relates to a trade-by-trade platform for the exchange of goods between a seller and a buyer.

### BACKGROUND

Buying and selling is an indispensable part of the life of humans. One person cannot himself fulfill all the necessities of life but have to buy from others in exchange for other goods or simply pay using the currency bills. Goods or services are generally priced taking into account multiple factors such as cost of raw material, labor, transportation, profits, and like. Most of the goods for fulfilling necessities of life are priced as such. However, not all the necessities have the same formula for valuation. Many necessities, such as real estate property, old goods, and like are valued based on demand and supply. For good having less demand, the valuation can be very difficult. The buyer may end up paying extra or the seller may get less value when valuation cannot be done or cannot be done up to satisfaction, or the price of a necessity fluctuates rapidly.

Thus, a long and unsolved desire is there for a trade-by-trade platform that allows buying and selling necessities without the aforesaid drawbacks of convention methods based on valuation.

The term “necessity” is interchangeably used with the term “product” and includes goods, properties, services, and like.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a trade-by-trade platform for exchanging necessities.

It is another object of the present invention to make the trade of necessities fun and friendly.

It is still another object of the present to remove uncertainty in trade.

It is yet another object of the present invention that the trade-by-trade platform makes transactions economical.

It is an additional object of the present invention that the trade-by-trade platform allows exchanging no-longer-needed or undesired necessities with desired necessities.

It is a further object of the present invention that the trade-by-trade platform reduces the tax burden on transactions.

It is still a further object of the present invention that the trade-by-trade platform prevents wastage of necessities.

In one aspect, disclosed is a trade-by-trade platform for trading a necessity in return for another necessity. The disclosed platform can provide an interface for the first user and the second user to upload the necessities for exchanging. The platform can receive the listings through the interface and store them in a structured format that can be queried through the interface. Either user can search for listings or navigate to find a desired necessity or product. Upon finding the desired necessity, the user can offer another user his listed necessity for exchange of the desired necessity from another user. Another user through the interface can review the offer. The disclosed platform may also allow the users to communicate and/or negotiate the transaction, wherein the interface can be configured to stamp date and time to the communication or negotiation.

These and other objects and advantages of the embodiments herein and the summary will become readily apparent from the following detailed description taken in conjunction with the accompanying drawings

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environmental diagram showing the disclosed system having the trade-by-trade platform in communication with two user devices, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a trade-by-trade platform for allowing a user to buy a necessity in exchange for another necessity. The necessity can be goods, services, properties, and like of general use of humans. The goods can be new or used. The necessities can include houses, cars, jet planes, vans, trucks, motorcycles, boats, bikes, furniture, kitchens equipment, antiques, coins, arts, books, clocks, televisions, music equipment, video, cell phones, cameras, camcorders, clothes, shoes, toys, jewelry, commercial buses, tractors, trucks, factory equipment, sewing equipment, etc. Generally, a user can sell a no-longer-needed or an undesired necessity with a desired necessity. For example, kids generally get bored of their toys and parents have to frequently buy new toys. The old toys may get wasted or can be sold at a very less value compared to their buy price. The disclosed trade-by-trade platform may allow the parents to exchange the used toys with used different toys saving the huge cost of buying the new toys.

Similarly, many people change their houses for different reasons, for example just for a change, or change in the locality, or to be closer to their loved ones. Using the convention method, a user generally first sells his house using the services of an agent and then again, using the services of an agent, buys the desired house. This involves multiple transactions combined with agency fees and taxes can make the process complex, costly, and uncertain, resulting in loss or unsatisfaction to the user. The disclosed trade-by-trade platform may bring the prospective buyers together to trade their necessities. For example, the user can buy the desired house in exchange for his house or any other necessity.

Besides the transfer of properties, users may also be looking for vacation homes for a predefined duration, such as 3 months. The disclosed platform may allow users to exchange homes for fixed durations. The disclosed platform brings two prospective buyers together, wherein each buyer has something to exchange.

In one case, a first family is having 2 or more children of different ages. The older kid may have used clothing or a garment that is no longer needed, maybe because of the size of the clothing. The younger kid may need toys. The disclosed trade-by-trade platform may allow the family to exchange the garment of the old kid with toys for the young kids. A second family may be having kids who need new clothes and also have many unused toys can exchange the toys for cloth. The disclosed trade-by-trade platform can bring the first family and the second family together. Moreover, the trade-by-trade platform provides for presenting the necessities through an interface.

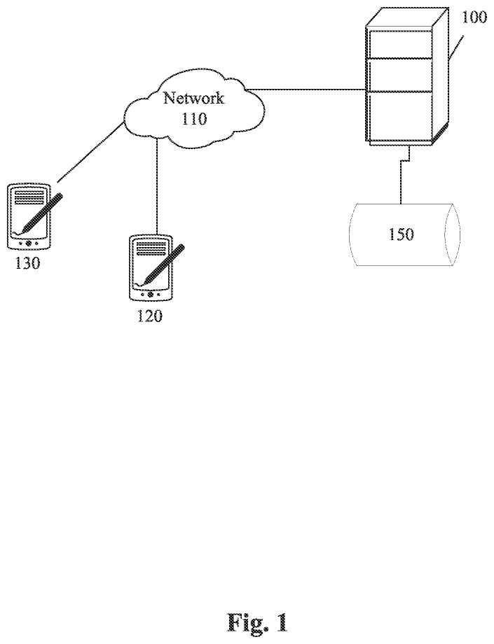

Referring to FIG. 1 which shows the disclosed system 100 having the trade-by-trade platform. The user devices, such as smartphones, laptops, desktops, tablet computers, personal digital assistants (“PDA”), and the like can be provided with an interface by the disclosed trade-by-trade platform. The user devices can be connected to the system through wired or wireless network 110. The wired network may include Digital Subscriber Line (DSL), coaxial cable lines, or optical fiber lines. The wireless network may include BLUETOOTH, Wi-Fi, Worldwide Interoperability for Microwave Access (WiMAX), an infrared channel, or satellite band. The wireless network may also include any cellular network standards used to communicate among mobile devices, including standards that qualify as 3G, 4G, or 5G. Examples of cellular network standards include AMPS, GSM, GPRS, UMTS, LTE, LTE Advanced, Mobile WiMAX, and WiMAX-Advanced.

FIG. 1 shows a first user device 120 and a second user device 130 connected to the system 100 through the network 110. It is to be understood that although FIG. 1 shows two user devices connected to the system, multiple devices can simultaneously connect to the system without departing from the scope of the present invention. Also, FIG. 1 shows the two user devices and the system connected through a common network, however, it is obvious that the different user devices may connect through different networks and one user device may connect through more than one network. Each the first user device and the second user device can be provided with an interface. The interface can be provided as application software that can be installed on a user device. The application software can be developed for Windows, Android, iOS, and any other known operating platform for mobile devices. The application software can be made available through a distribution service provider, for example, Google Play operated and developed by Google, and the app store by Apple. In addition to the application software, a website-based interface can also be provided through the world-wide-web.

The interface allows the new users to register with the trade-by-trade platform. The user may be required to provide their contact details, addresses, and like. Also, the user may need to provide any authentication detail or document for verification. The trade-by-trade platform may also provide for verification of the users before or after registration to avoid fake or fraudulent users. Once registered, a user can create a listing. The interface can provide an option to create a listing. The trade-by-trade platform can present predefined categories to the user. Such categories may be multi-level categories that can help to keep the listings organized. The categories and subcategories can be navigated by the user. For example, a kid category can have subcategories of cloth and toys. Once, the desired category can be selected by the user, an option to create the listing under the selected category can be presented on the interface. The interface can provide a form having predefined fields to capture structured information about the necessity being listed by the user. Additional details can also be entered by the user in the form of free text. Photographs of the listing can also be uploaded by the user. Once completed, the user can review and save the listing. The listing can be modified after reviewing and before saving. Additionally, the listings can also be modified after saving the listing.

The trade-by-trade platform can receive the listings from the user through the interface. The listing can be saved in a database 150. The database can be a SQL-based database that may allow querying and other features provided by SQL-based databases. It is to be understood that any other database is within the scope of the present invention. The listing can then be published for the users of the platform to view. Before, publishing the listings, the trade-by-trade platform may also provide for an approval process for the listings. The trade-by-trade platform may provide for verifying the listings, such as sufficient details are included in the listings or any illegal product is not listed. After such verification, the trade-by-trade platform may provide for publishing the listings.

The trade-by-trade platform can also provide another interface through which a user can view available listings on the database. The interface can provide a list of categories through which a user can navigate to get the desired category. For example, a user looking for girl clothes can look into kids' category, then girl's sub-category, and thereafter the cloth subcategory. The user can then navigate through the listing associated with the selected category. Additionally, a search form can also be provided by the trade-by-trade platform on the interface. The search form can receive keywords from the user and query the database with the keywords. The retrieved listings can then be displayed to the user. For example, the user can enter keywords like home in some areas and the trade-by-trade platform can retrieve the listings of the homes in some areas. Additionally, the interface can provide further refine options or filters to narrow down the results presented by the home in some areas. For example, the user can refine the results based on the size or age of the property.

Searching through the listings, a user through the interface can find the desired necessity which the user is interested to procure. Upon identifying the desired necessity, the user can prepare an offer. The offer may include an intention to procure the desired necessity or simply an interest in the desired necessity. The offer may also include an offered necessity which is offered by the user in exchange for the desired necessity, the offer may also include an intention for exchanging the desired necessity with the offered necessity. The interface may allow a user to select the listing of the offered necessity from available listings of the users. Alternatively, the user may create a new listing for the offered necessity. The offer can then be presented by the trade-by-trade platform to the owner of desired necessity, referred to hereinafter as the second user. The second user can review the offer and may accept or deny the offer. The second user may also communicate with the first user (the user making the offer) and learn more about the listings. The trade-by-trade platform may also provide an interface for the two users in a transaction to communicate and negotiate. Some transactions can be finalized on the disclosed interface, others may require additional steps to be taken by the users. For example, a deal to exchange clothes for toys can be finalized on the trade-by-trade platform and the items can be exchanged physically or through courier services. A transaction like the exchange of houses may require additional steps of registration and services of professionals outside the trade-by-trade platform.

The disclosed trade-by-trade platform can also provide for making and verifying agreements for transactions taking place on the trade-by-trade platform. Professionals, like attorneys for registration, can also be connected to the disclosed trade-by-trade platform. Other services like a payment interface and shipping interface can also be provided by the disclosed trade-by-trade platform. Any fee related to the transactions, agent fee, taxes and the like can be paid on the disclosed trade-by-trade platform. The shipping interface may provide for parties in the transaction to courier the offered necessity and the desired necessity respectfully. The interface may also provide an option for the parties to track the shipment. In one exemplary embodiment, the goods may be handover to the parties in the transaction only when both parties have a chance to verify the goods being received.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented method for trading a necessity in exchange for another necessity, the computer-implemented method comprising the steps of:
receiving, by a trade-by-trade platform, through a first user interface, a first listing from a first user, the first listing associated with a first product;
receiving, by the trade-by-trade platform, through a second user interface, a second listing from a second user, the second listing associated with a second product;
receiving, by the trade-by-trade platform, from the first user an offer, the offer comprises an interest in the second product, the first listing, and an intention to exchange the first product for the second product;
upon receiving the offer, presenting by the trade-by-trade platform on the second user interface, the offer; and
presenting, by the trade-by-trade platform, a third user interface for the first user and the second user to communicate.

2. The computer-implemented according to claim 1, wherein the computer-implemented method further comprises the steps of:
receiving a registration request, by the trade-by-trade platform, from the first user and the second user, and upon registration receiving the listings from the first user and the second user.

3. The computer-implemented according to claim 1, wherein the first product is a toy, and the second product is a garment.

4. The computer-implemented according to claim 1, wherein the first product is a first residential property, and the second product is a second residential property.

5. The computer-implemented according to claim 1, wherein the first product is a first vacation home, and the second product is a second vacation home.

6. The computer-implemented according to claim 1, wherein the third interface is configured to stamp date and time to the communication.

7. The computer-implemented according to claim 1, wherein the computer-implemented method further comprises:
providing a shipping interface to the first user and the second user, wherein the shipping interface is configured to:
receive a request from the first user to courier the first product to the second user,
receive a request from the second user to courier the second product to the first user, and
providing an option to the first user and the second user to track the shipping status of the first product and the second product.

8. The computer-implemented according to claim 1, wherein computer-implemented method further comprises:
providing a payment interface to the first user and the second user.

9. The computer-implemented according to claim 1, wherein computer-implemented method further comprises:
receiving, by the trade-by-trade platform, from the first user, a query;
retrieving, from a database, by the trade-by-trade platform, a list of listings based on the query; and
presenting, by the trade-by-trade platform, on the first user interface, the list of the listings, wherein the second listing is included in the list of listings.
